(19) United States
(12) Patent Application Publication
(10) Pub. No.: US 2020/0361346 A1
(43) Pub. Date: Nov. 19, 2020

(54) Car Seat Accessory

(71) Applicant: Alicia Denise Chevalier, Woodslee (CA)

(72) Inventor: Alicia Denise Chevalier, Woodslee (CA)

(21) Appl. No.: 16/410,940

(22) Filed: May 13, 2019

(51) Int. Cl. B60N 2/28

(52) U.S. Cl. CPC B60N 2/2806; B60N 2002/2815

(57) ABSTRACT

A child car seat accessory configured to facilitate the journaling of a vehicle seat belt buckle through the frame of the car seat. The child car seat accessory includes a body having a first portion and a second portion. The first portion of the body is formed in a loop and is configured to be moveably secured to a frame of a child car seat. The first portion of the body includes a first end and a second end that are releasably secured. The body includes a second portion wherein the second portion includes a first end and a second end. The second portion is secured to the first portion at the first end of the second portion. The second portion extends outward from the first portion and is elongated in manner. The second end of the second portion of the body includes a fastener.

### FIELD OF THE INVENTION

The present invention relates generally to automobile car seats, more specifically but not by way of limitation an accessory for a child automobile car seat that is configured to be superposed an automobile seat wherein the present invention is configured to provide assistance with journaling a seat belt through the frame of the child automobile car seat so as to facilitate the securing thereof.

### BACKGROUND

As is known in the art, infants and small children require special car seats in order to ensure their safety when traveling in an automobile. These car seats are designed to retain the body of the small child in a position that is most desirable in the event of a vehicle accident. Conventional car seats typically include a five point harness or other similar seat belt harness that provides improved protection for a child occupant. The car seats are constructed of a frame that is configured to define an occupant cavity wherein the occupant cavity is typically provided with a cushion and covering thereof.

One issue with installation of conventional car seats is the journaling of the automobile seat belt through the frame of the child car seat. Most child car seats are cumbersome and ensuing being superposed on the vehicle seat access to the rear thereof becomes challenging. In order to properly secure most child car seats, the automobile seat belt must be operably coupled to the frame of the child car seat. In order for the aforementioned to occur, an individual must journal one portion of the vehicle car seat through apertures or similar elements that are formed in the frame of the child car seat. Once in position this task can be quite difficult. Journaling a nylon belt is difficult due to its lack of rigidity and attempting to reach through the apertures of the child car seat with a hand may not be possible.

Accordingly, there is a need for a child car seat accessory that assists in the journaling of a car seat belt through the frame of a child car seat.

### SUMMARY OF THE INVENTION

It is the object of the present invention to provide a child car seat accessory that is configured to provide assistance in securing an automobile car seat to a child car seat wherein the present invention can be permanently installed on a child car seat or be a releasably secured accessory thereon.

Another object of the present invention is to provide a child car seat accessory configured to facilitate the engagement of a vehicle seat belt with the frame of a child car seat wherein the present invention includes a body having a first portion and a second portion.

A further object of the present invention is to provide a child car seat accessory that is configured to provide assistance in securing an automobile car seat to a child car seat wherein the first portion of the body is annular in shape.

Still another object of the present invention is to provide a child car seat accessory configured to facilitate the engagement of a vehicle seat belt with the frame of a child car seat wherein the first portion of the body includes a first end and a second end.

An additional object of the present invention is to provide a child car seat accessory that is configured to provide assistance in securing an automobile car seat to a child car seat wherein the first end and second end of the first portion of the body are releasably secured with a mateable fastener.

Yet a further object of the present invention is to provide a child car seat accessory configured to facilitate the engagement of a vehicle seat belt with the frame of a child car seat wherein the second portion of the body is secured to the first portion and extends outward therefrom.

Another object of the present invention is to a provide a child car seat accessory that is configured to provide assistance in securing an automobile car seat to a child car seat wherein the second portion includes a first end and a second end wherein the first end is secured to the first portion of the body.

An alternate object of the present invention is to provide a child car seat accessory configured to facilitate the engagement of a vehicle seat belt with the frame of a child car seat wherein the second portion of the body is elongated in manner.

Still a further object of the present invention is to provide a child car seat accessory that is configured to provide assistance in securing an automobile car seat to a child car seat wherein the second end of the second portion of the body includes a fastener.

An additional object of the present invention is to provide a child car seat accessory configured to facilitate the engagement of a vehicle seat belt with the frame of a child car seat wherein the fastener of the second end is configured to be releasably secured to a buckle portion of a vehicle seat belt.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of a preferred embodiment of the present invention engaged with an exemplary car seat; and

FIG. 2 is a perspective view of the preferred embodiment of the present invention.

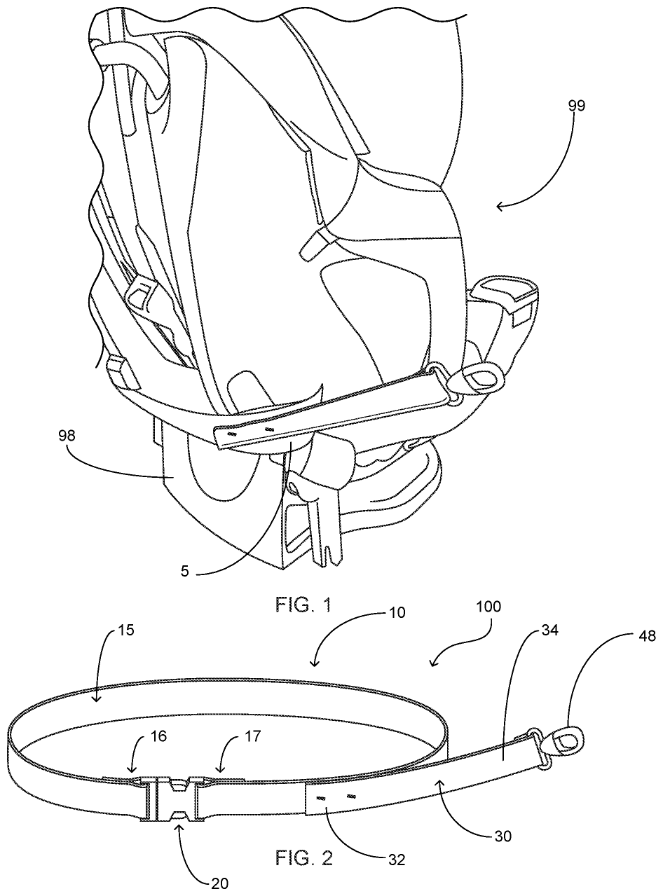

### DETAILED DESCRIPTION

Referring now to the drawings submitted herewith, wherein various elements depicted therein are not necessarily drawn to scale and wherein through the views and figures like elements are referenced with identical reference numerals, there is illustrated an car seat accessory 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the car seat accessory 100 includes a body 10. The body 10 is manufactured from a durable flexible material such as but not limited to nylon. The body 10 includes a first portion 15 and a second portion 30. The first portion 15 of the body 10 is annular in shape and includes a first end 16 and a second end 17. The first end 16 and second end 17 are releasably secured to each other utilizing mateable portions of a fastener 20. It is contemplated within the scope of the present invention that the fastener 20 could be manufactured from various conventional fasteners such as but not limited to a parachute buckle. Furthermore, it should be understood within the scope of the present invention that while the first portion 15 is illustrated herein as having a first end 16 and a second end 17, the first portion 15 of the body 10 could be formed as one piece and movably secured to the frame 98 of an exemplary child car seat 99. The first portion 15 ensuing being secured to the frame 98 is movable in a circular type pattern wherein the user is able to engage an exteriorly presenting section 5 of the first portion 15 so as to feed the second portion 30 through the frame 98. As the user engages the exteriorly presenting section 5, the user will move the first portion in a consistent direction and as such a result of a circular movement of the first portion will occur. This movement of the first portion facilitates the feeding of the second portion 30 through the frame 98.

The second portion 30 of the body 10 is secured to the first portion 15 utilizing suitable durable techniques. The second portion 30 is manufactured from a similar material as the first portion 15 such as but not limited to nylon. The second portion 30 is elongated in manner and includes a first end 32 and a second end 34. The second portion 30 is configured to be releasably secured to a vehicle seat belt so as to facilitate the journaling thereof through the frame 98 in order to fasten to its mateable portion on the opposing side of the car seat 99.

Secured to the second end 34 of the second portion 30 of the body 10 is fastener 40. Fastener 40 is a clip style fastener that is operable to be releasably secured to a portion of a vehicle seat belt. While no particular style of fastener is required, it is desired within the preferred embodiment of the present invention that the fastener 40 be a swivel mount style fastener. Utilization of a swivel mount style fastener facilitates the positioning of the portion of the seat belt buckle in an orientation that improves the journaling through the frame 98. It should be understood within the scope of the present invention that the second portion 30 could be manufactured in alternate lengths. Furthermore, while not illustrated herein, it is contemplated within the scope of the present invention that the body 10 could have a foam collar or similar element surroundably mounted to a portion thereof to assist in the initial attachment of the body 10 to a frame 98 of a car seat 99.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

1. A child car seat accessory configured to facilitate the attachment of a vehicle seat belt to a child car seat comprising:
a body, said body having a first portion and a second portion, said first portion of said body being annular in shape, said first portion being movably coupled to the child car seat, said second portion of said body having a first end and a second end, said first end of said second portion of said body being secured to said first portion; and
wherein said second end of said second portion is configured to be secured to a portion of the vehicle seat belt.

2. The child car seat accessory as recited in claim 1, wherein said first portion of said body is secured to the child car seat.

3. The child car seat accessory as recited in claim 2, wherein said second end of said second portion includes a fastener, said fastener being configured to secure to a the vehicle seat belt seat belt.

4. The child car seat accessory as recited in claim 3, wherein said first portion of said body is moved in a circular pattern so as to provide an exteriorly presenting section thereof so as to facilitate movement of the second portion of the body and as such a portion of the vehicle seat belt on a proximate side of the child car seat.

5. The child car seat accessory as recited in claim 4, wherein as the first portion is moved through the child car seat so as to journal the second portion therethrough.

6. The child car seat accessory as recited in claim 5, wherein the body is manufactured from nylon.

7. A child car seat accessory configured to facilitate the journaling of a vehicle seat belt buckle through the frame of a child car seat wherein the child car seat accessory comprises:
a body, said body having a first portion and a second portion, said first portion of said body being annular in shape, said first portion of said body being movably secured to the the child car seat, said first portion of said body having a first end and a second end, said first end and said second end of said first portion of said body being releasably secured, said second portion of said body having a first end and a second end, said first end of said second portion of said body being secured to said first portion; and
wherein said second end of said second portion is configured to be secured to a portion of the vehicle seat belt.

8. The child car seat accessory as recited in claim 7, wherein said second end of said second portion includes a fastener, said fastener being configured to secure to the seat belt buckle.

9. The child car seat accessory as recited in claim 8, wherein said first end and said second end of said first portion of said body include mateable fasteners configured to provide the releasable securing thereof

10. The child car seat accessory as recited in claim 9, wherein said first portion of said body is moved in a circular pattern so as to provide a section of said second portion having the seat belt buckle secured thereto.

11. The child car seat accessory as recited in claim 10, wherein the body is manufactured from nylon.
